(19) United States
(12) Patent Application Publication
(10) Pub. No.: US 2024/0328719 A1
(43) Pub. Date: Oct. 3, 2024

(54) HEAT EXCHANGER

(71) Applicant: VALEO AUTOSYSTEMY SP. Z O.O, Skawina (PL)

(72) Inventors: Dariusz Potok, Skawina (PL); Agnieszka Bujas, Skawina (PL); Krzysztof Machul, Skawina (PL); Adrian Nowakowski, Skawina (PL); Magdalena Malina, Skawina (PL)

(73) Assignee: VALEO AUTOSYSTEMY SP. Z O.O, Skawina (PL)

(21) Appl. No.: 18/580,611

(22) PCT Filed: Jul. 19, 2022
(86) PCT No.: PCT/EP2022/070130

§ 371 Date: Jan. 19, 2024

(30) Foreign Application Priority Data
Jul. 22, 2021 (EP) 21187195.9

(51) Int. Cl. F28D 7/16; F28D 21/00; F28F 9/00; F28F 9/02

(52) U.S. Cl. CPC F28D 7/1661; F28F 9/001; F28F 9/0224; F28D 2021/0063; F28D 2021/0082; F28F 2230/00

(57) ABSTRACT

A heat exchanger is provided. The heat exchanger includes a bundle of elongated tubes having open ends for a first fluid, a pair of manifolds and a housing. The pair of manifolds located on both sides of the open ends of the elongated tubes. The housing is configured to form a conduit for the second fluid and at least partially encapsulating the elongated tubes. The housing includes an inner surface facing the elongated tubes and at least one connection point formed by two perpendicular portions of the housing. Further, one of the perpendicular portions has a bent section forming the connection point by parallel arrangement with the other portion. The heat exchanger further includes at least one sealing portion located at least within the housing, so that the sealing portion overlaps at least portion of the connection point adjacent to at least one manifold.

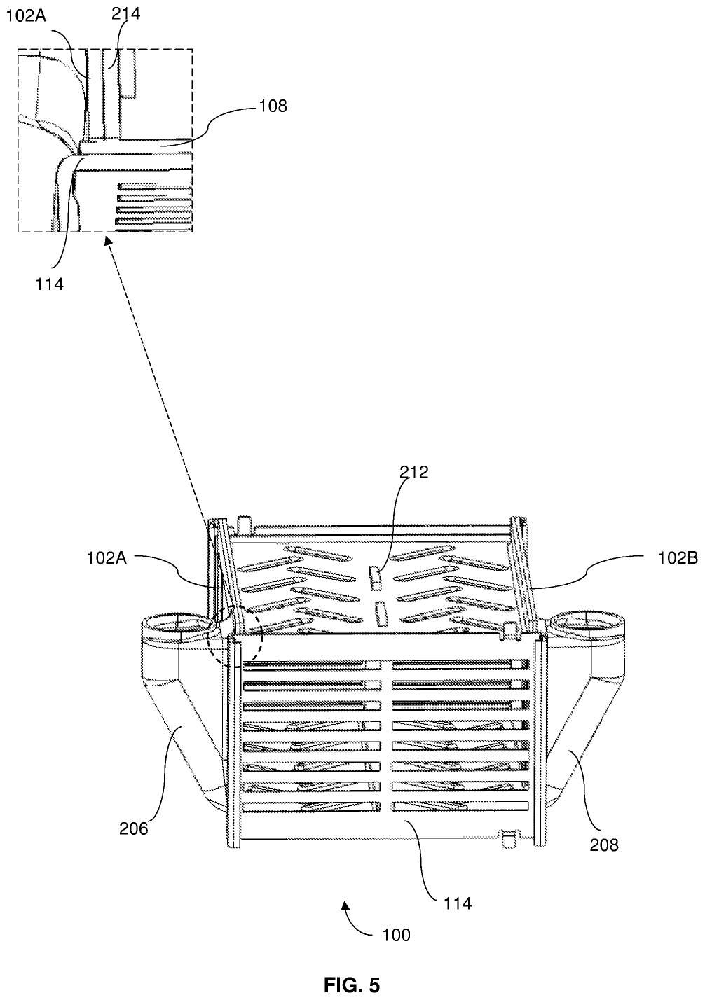

FIG. 5 is to be published along abstract.

The present invention relates to heat exchangers. In particular, this invention relates to heat exchangers having brazing connection points.

Generally, the heat exchangers such as chillers, charge air coolers and water condensers may be formed by different parts connecting together. Such parts may be a housing, a cover plate, headers, etc. connected together to form the heat exchanger. The heat exchanger includes two different fluid circuits, fluidically isolated from each other, yet thermally coupled with each other. The fluid circuits are formed in the housing, and the housing is formed of side plates and bottom plates. In such cases, the side plates and the bottom plates are usually brazed together along the cover plate. Further, brazing the three different elements together at a point is cumbersome and it may lead to improper brazing, as the different elements may have asynchronous tolerances, so the brazing between the three different elements is not optimal and it may lead to leakage of fluid from the housing. Further, a gap may be formed at the connection points of the cover plate, the side plates and the header due to asynchronous tolerance of the three different elements. Such gap in the housing may lead to leakage of fluid from the housing, since brazing at the connection points is not optimal.

In some heat exchangers, it is possible to have the connection points on the both sides of the heat exchanger. As the brazing points/connection points are on both side of the heat exchanger, the connection points can be at the top side of the heat exchanger, while the heat exchanger is placed in a brazing machine. While placing the heat exchanger in the brazing machine, the brazing points may be located at the top side of the heat exchanger, so there is a possibility of flow of the molten brazing material or debris towards the core of the heat exchanger due to gravity. This may lead to insufficient accumulation of the brazing material in the vicinity of the connection points which may result in lack of fluid-tightness of the assembly. Further, it may affect the alignment and geometry of the core, which leads improper assembling of the heat exchanger.

Accordingly, there remains a need for a heat exchanger having limited brazing points to avoid any leakage from the heat exchanger. Further, there remains a need for a heat exchanger having brazing points at one side of the heat exchanger to avoid contact of the brazing materials with a core of the heat exchanger during brazing process in a brazing machine. Further, there remains a need for a heat exchanger with brazing points connecting limited elements together.

In the present description, some elements or parameters may be indexed, such as a first element and a second element. In this case, unless stated otherwise, this indexation is only meant to differentiate and name elements, which are similar but not identical. No idea of priority should be inferred from such indexation, as these terms may be switched without betraying the invention. Additionally, this indexation does not imply any order in mounting or use of the elements of the invention.

In view of the foregoing, an embodiment of the invention herein provides a heat exchanger that includes a bundle of elongated tubes having open ends for a first fluid, a pair of manifolds and a housing. The pair of manifolds located on both sides of the open ends of the elongated tubes. The housing is configured to form a conduit for the second fluid and at least partially encapsulating the elongated tubes. Further, the housing includes an inner surface facing the elongated tubes and at least one connection point formed by two perpendicular portions of the housing. Furthermore, one of the perpendicular portions has a bent section forming the connection point by parallel arrangement with the other portion. The heat exchanger further includes at least one sealing portion located at least within the housing, so that the sealing portion overlaps at least portion of the connection point adjacent to at least one manifold . . . .

Further, the manifold includes at least one header comprising open ends to receive the elongated tubes.

In one embodiment, the header is encapsulated by the housing.

In another embodiment, the header is located beyond the housing.

In another aspect, the housing is formed by at least one plate comprising at least one connection point.

In one embodiment, the housing is formed by a base portion and a cover plate. The cover plate with base portion forming in particular two connection points.

Further, the base portion is essentially U-shaped portion, the cover plate is essentially a flat portion. The cover plate includes bent sections for arranging the connection points at the terminal ends thereof.

Further, the cover plate includes at least one separator configured to form a path for the second fluid within the housing. The cover plate further includes a separator receiver configured to fix the separator perpendicularly to the cover plate.

Further, the housing includes a depletion configured to receive the free end of the separator in the base portion.

Further, the separator includes a recessed section configured to form fluid communication between the two-sections of fluid flow within the housing.

In one embodiment, wherein the sealing portion is formed by an elongated L-shaped portion.

In another embodiment, the sealing portion is formed by an elongated ring portion.

Further, the sealing portion includes a spacer plate protruding therefrom, and the spacer plate is located in-between the manifold and the housing.

Other characteristics, details and advantages of the invention can be inferred from the description of the invention hereunder. A more complete appreciation of the invention and many of the attendant advantages thereof will be readily obtained as the same becomes better understood by reference to the following detailed description when considered in connection with the accompanying figures, wherein:

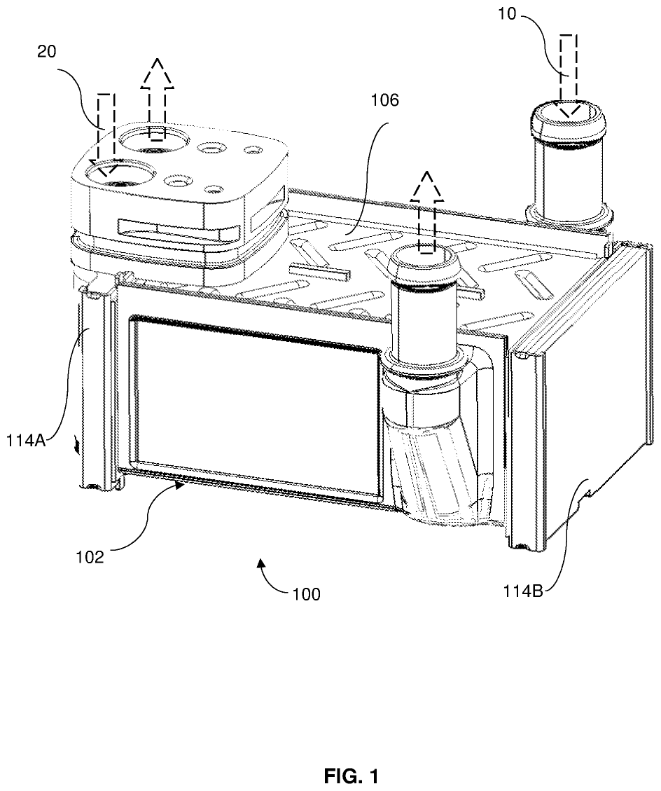

FIG. 1 illustrates a perspective view of a heat exchanger, wherein a header is located beyond the housing.

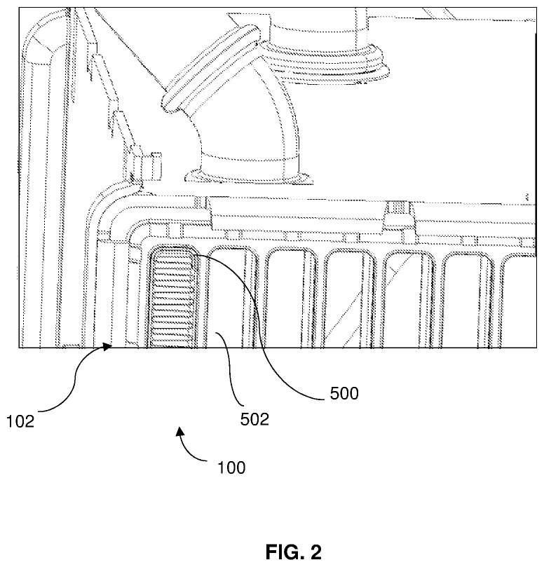

FIG. 2 illustrates a perspective view of the heat exchanger, wherein the header is located within the housing.

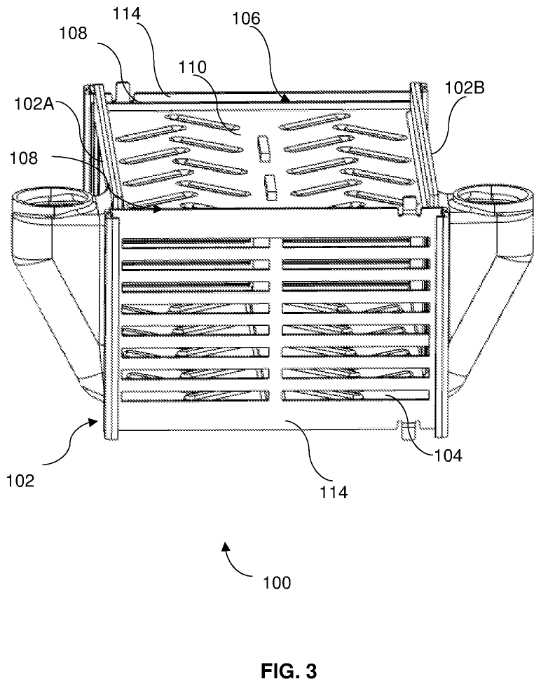

FIG. 3 illustrates another perspective view of the heat exchanger of FIG. 1 showing location of the header.

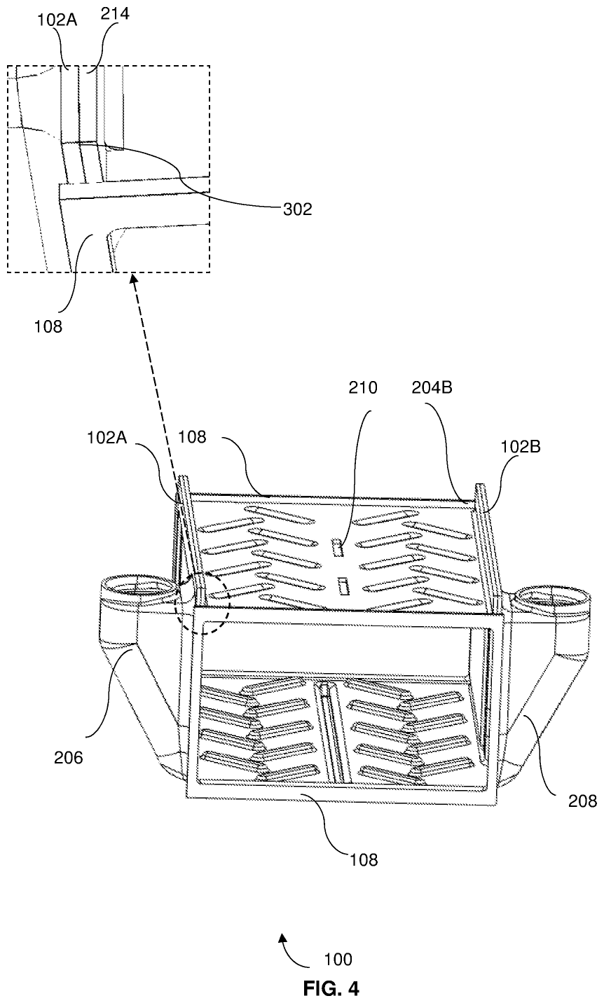

FIGS. 4 and 5 illustrate schematic views of the heat exchanger of FIG. 1 provided with cover plate connected between perpendicular portions of a housing of the heat exchanger.

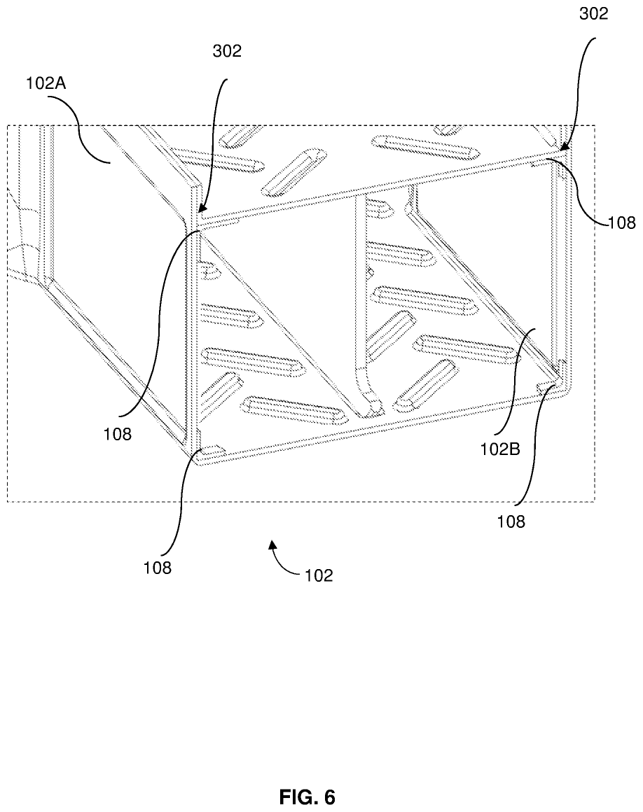

FIG. 6 illustrates a schematic view of the housing of FIG. 4 with an L-shaped sealing portion overlapping connection points.

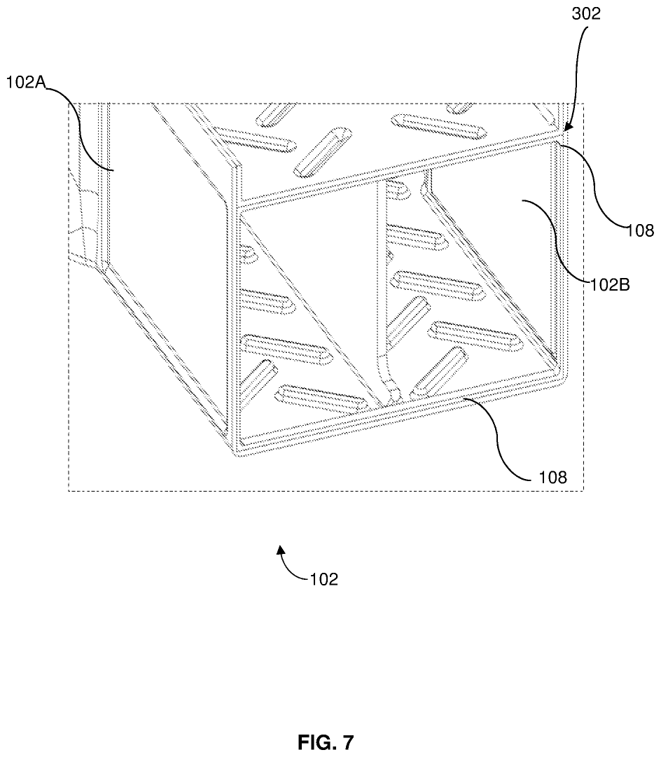

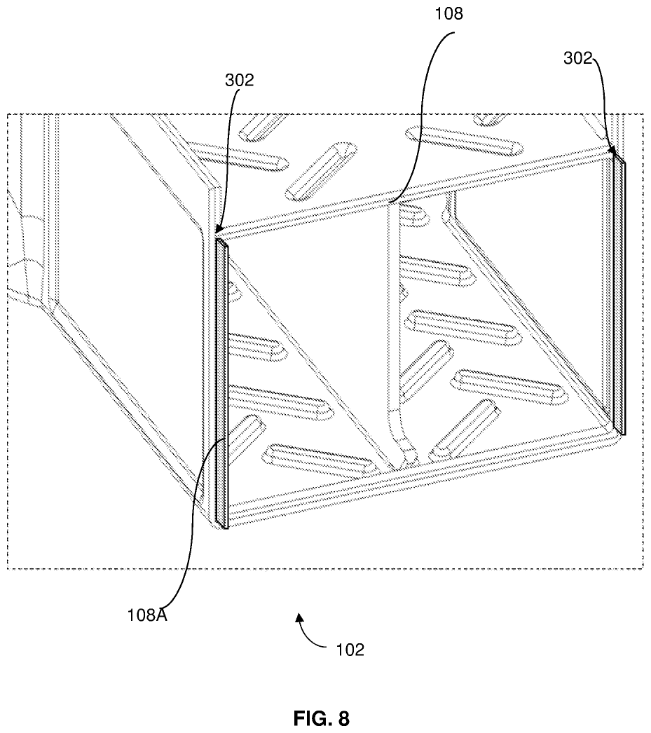

FIGS. 7 and 8 illustrate schematic views of the sealing portion overlapping the connection points of the housing of FIG. 4.

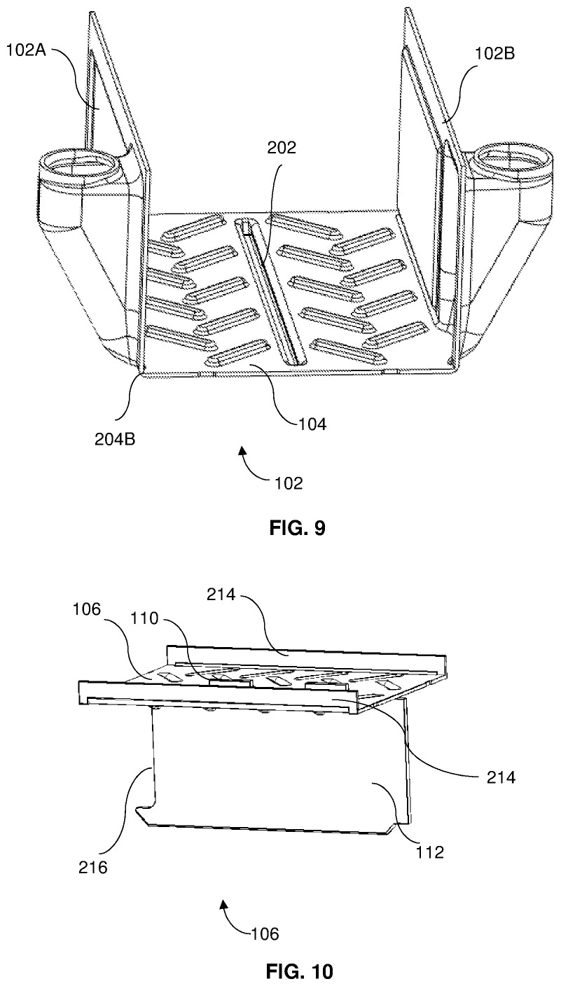

FIG. 9 shows a perspective view of the housing of the heat exchanger of FIG. 4.

FIG. 10 illustrates a perspective view of the cover plate of FIG. 4.

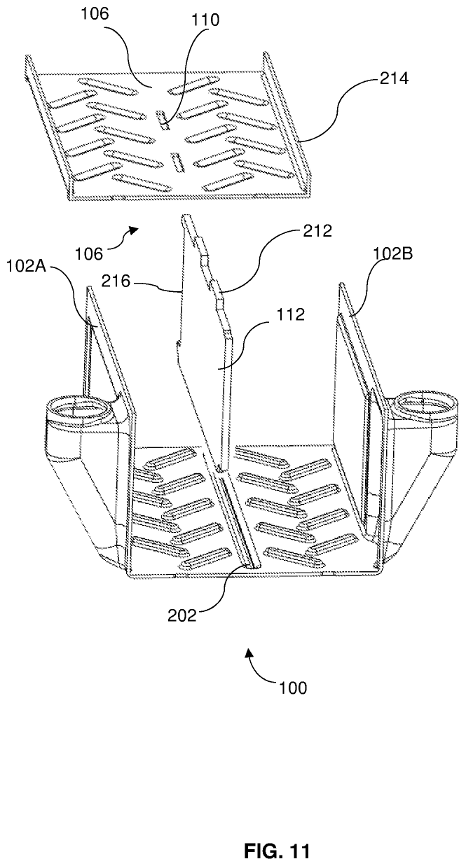

FIG. 11 illustrates an exploded view of the housing of FIG. 4.

It must be noted that the figures disclose the invention in a detailed enough way to be implemented, the figures helping to better define the invention if need be. The invention should however not be limited to the embodiment disclosed in the description.

The present invention relates a heat exchanger provided with brazing points at one side of the heat exchanger for example chiller, charge air cooler or water condenser. Conventional heat exchangers may have more number of elements to be brazed together at the connection points to form the heat exchanger. There is a possibility that the heat exchanger may have the connection points on which three different elements are to be brazed together. Such configuration may cause fluid leakage from the connection points, since a gap may be formed due to lack of tolerance of the different elements. In some of conventional heat exchangers, the connection points can be at both sides of the heat exchanger. In such cases, some of the connection points can be at the top side of the heat exchanger, while placing the heat exchanger in the brazing furnace. Therefore, the molten brazing material or debris may flow into the core of heat exchanger due to gravity, while brazing the heat exchanger, which may damage the core. To overcome such problems, the proposed heat exchanger is provided with the connection points having three elements at the one side of the heat exchanger, so that the heat exchanger can be positioned in the brazing machine in a way that the connection points are pointing towards bottom of the brazing machine. Hence, the brazing material may not flow towards the core of the heat exchanger during the brazing process. Further, the heat exchanger is provided with sealing portions such as adapters that overlap the connection points having the three different elements, which needs to be brazed together. Therefore, leakage from the connection points of the heat exchanger can be avoided.

FIGS. 1 and 3 illustrate perspective views a heat exchanger 100, in accordance with an embodiment of the present invention. In this embodiment, the heat exchanger 100 may be a chiller, whereas the heat exchanger 100 shown in FIG. 2 may be, for example, the charge air cooler in which a header 114 is located within a housing 102. In the present example, FIG. 1 is a perspective view of the heat exchanger 100. In addition, FIG. 3 is a perspective view of the housing 102 of the heat exchanger 100 without the manifolds 114A-B and the heat exchange elements. The heat exchanger 100 may comprise two fluid circuits, fluidically isolated from each other, and yet thermally coupled to each other. The both fluid circuits are tightly packed in the heat exchanger 100. Further, a first fluid circuit being a coolant fluid circuit 10 and a second fluid circuit being a refrigerant fluid circuit 20, thermally coupled with each other. In the present embodiment, a coolant flowing in the coolant fluid circuit 10 is water. The coolant fluid circuit 10 and the refrigerant fluid circuit 20 are tightly packed together to have effective heat exchange between the coolant fluid circuit 10 and the refrigerant fluid circuit 20. The heat exchanger 100 includes a plurality of heat exchange elements 500 in which the both fluid circuits are formed. In one embodiment, the coolant fluid circuit 10 may be formed around the plurality of heat exchange elements and the refrigerant fluid circuit 20 may be formed through the plurality of heat exchange elements. The plurality of heat exchange elements can be elongated tubes. The plurality of heat exchange elements, hereinafter referred to as elongated tubes 500, having open ends adapted to be received in openings 502.

The heat exchanger 100 further includes the housing 102 configured to form a conduit for the second fluid 20 and adapted to at least partially encapsulate the elongated tubes 500. The pair of headers 114 is coupled to the housing 102 to receive the elongated tubes 500. The pair of headers 114 may comprise openings 502 to receive the elongated tubes 500. In one embodiment, the housing 102 encapsulates the pair of headers 114. In another embodiment, the pair of headers 114 is located beyond the housing 102. In one embodiment, the housing 102 includes an inner surface facing the elongated tubes 500, and at least two perpendicular portions 102A-B spaced apart from each other. Further, the cover plate 106 is connected between the two perpendicular portions 102A-B as shown in FIG. 2. In another embodiment, the housing 102 has the perpendicular portions 102A-B and a base portion 104. Further, the cover plate 106 and the base portion 104 may form two connection points. Further, the connection points may be the points in which the perpendicular portion 102A-B is connected with the cover plate 106. In this example, the connection points are further described with respect to forthcoming figures and shown in the following figures. In one embodiment, the housing 102 is formed by at least one plate 102A or 102B having at least one connection point. In another embodiment, the housing 102 is formed by the base portion 104 and the cover plate 106. In such case, the base portion 104 is a U-shaped portion and the cover plate 106 is flap portion. In another embodiment, the base portion 104 may be a plate connected between the perpendicular portions 102A-B.

As mentioned above, the cover plate 106 may be connected between the perpendicular portions 102A-B as shown in FIG. 2. In other words, the cover plate 106 is extending between the perpendicular portions 102A-B of the housing 102. Further, the perpendicular portion 102A-B, and the base portion 104 along with the cover plate 106 may form the closed housing, in which the elongated tubes 500 are received and the both fluid circuits 10, 20 are formed.

FIGS. 4 and 5 illustrate schematic views of the heat exchanger 100 of FIG. 1 provided with the cover plate 106 connected between the perpendicular portions 102A-B, in accordance with an embodiment of the present invention. More particularly, FIG. 5 shows the connection point 302 between the cover plate 106 and the perpendicular portions 102A-B and FIG. 6 shows the overlap portion of the header 114 and a sealing portion 108 on the connection point 302. The heat exchanger 100 further includes at least one sealing portion 108 located at least within the housing 102, so that the sealing portion 108 overlaps at least a portion of the connection points 302 adjacent to at least one manifold 114A-B. As the connection points 302 are adjacent to at least one manifold 114A-B, brazing can be applied at the ends of the housing 102. Further, the sealing portion 108 may be connected to the lateral sides of the housing 102. Further, the sealing portion 108 may overlap the connection points 302 between the cover plate 106, and the perpendicular portions 102A-B. Further, at least one portion amongst the perpendicular portions 102A-B has a bent section forming the connection point 302 by parallel arrangement with other portion. The header 114 may overlap the sealing portion 108 and the connection points 302 between the cover plate 106 and perpendicular portions 102A-B.

The headers 114 may be connected to a pair of tanks (not shown in Figures) to introduce/receive refrigerant to the housing 102. The housing 102 may further comprise an inlet 206 and an outlet 208 provided on the perpendicular portions 102A-B to enable coolant flow in the housing 102. As the coolant flow circuit 10 formed around the elongated tubes 500, the inlet 206 is adapted to introduce the coolant to the coolant fluid circuit 10 and the outlet 208 is adapted to exit the coolant from the coolant fluid circuit 10.

In one example, the sealing portion 108 is brazed to the lateral sides of the housing 102 to overlap the connection points 302 between the cover plate 106 and the perpendicular portions 102A-B. Further, both ends of the cover plate 106 are bent perpendicularly to couple with the perpendicular portions 102A-B. In other words, the cover plate 106 includes bent sections 214 for arranging the connection points 302 are at terminal ends thereof. The connection points 302 are the point in which the ends 214 of the cover plate 106 and the perpendicular portions 102A-B are connected thereon. The sealing portion 108 is adapted to overlap the connection points 302 at least by 12% of area, when the sealing portion 108 is brazed to the connection points 302 of the housing 102. To braze the connection points 302, the housing 102 along with the cover plate 106 and the sealing portion 108 are placed in the brazing holder in such a way that the connection points 302 pointing the bottom of the brazing machine. The sealing portion 108 may reduce the header-header tolerance of the heat exchanger 100. As the heat exchanger 100 may have different elements connected together, there might be some tolerance between the pair of headers 114 while connected the pair of headers 114 to the housing 102. To compensate the tolerance, the sealing portion 108 is connected to the lateral side of the housing 102.

In one embodiment, the sealing portion 108 is formed by an elongated L-shaped portion as shown in FIG. 6. FIG. 6 illustrates a schematic view of the housing 102 with the L-shaped sealing portion 108 overlapping the connection points 302 on an inner side of the housing 102, i.e. the side facing the tubes 500. The sealing portion 108 may be brazed to the connection points 302 at the inner surface of the housing 102. In another embodiment, the sealing portion 108 is formed by an elongated ring portion as shown in FIG. 7. In other words, the elongated ring portion forms the sealing portion 108 that overlaps the connection points 302. FIGS. 7 and 8 illustrate schematic views of the sealing portion 108 overlapping the connection points 302 of the housing 102 of FIG. 4. In this embodiment, the sealing portion 108 is the elongated ring formed on the inner side of the housing 102. According to this embodiment, the sealing portion 108 may further include a spacer plate 108A protruded from the sealing portion 108 towards the at least one manifold 114A-B. Further, the spacer plate 108A may located in-between the manifold 114A-B and the housing 102.

FIGS. 9 and 10 illustrate perspective views of the housing 102 with the cover plate 106 of FIG. 3 respectively. In this example, FIG. 9 illustrates a perspective view of the housing 102 of FIG. 3, and FIG. 10 illustrates a perspective view of the cover plate 106 of FIG. 4. The housing 102 may be U-shaped housing. In such case, the base portion 104 is integrally formed with the perpendicular portions 102A-B, and the cover plate 106 is connected between the perpendicular portions 102A-B of the housing 102. As the base portion 104 is integrally formed with the perpendicular portions 102A-B of the housing 102, the connection points 302, in which ends of the cover plate 106 are connected, can be at one side of the housing 102. Therefore, it is possible to position the connection points 302 of the heat exchanger 100 facing the bottom of the brazing machine/furnace. In other words, the housing 102 along with the cover plate 106 is positioned in the brazing machine in such a way that the connection points 302 of the housing 102 lies in the bottom side of the brazing machine. Hence, the molten brazing materials, obtained during brazing process, are restricted from entering into the core of the heat exchanger 100, thereby avoiding damages on the core of the heat exchanger 100.

The cover plate 106 includes the bent sections 214 formed at both ends of the cover plate 106. Further, the bent section 214 arranges the connection points 302 at the terminal ends of the cover plate 106. Further, the cover plate 106 may further comprise a separator receiver 110 and a plurality of separators 112 perpendicularly connected to the separator receiver 110. In one aspect, the cover plate 106 may comprise at least one separator 110 configured to form a path for the second fluid 20 flowing within the housing 102. In one embodiment, the cover plate 106 may be in a form of a “T” shaped plate having the separator receiver 110 defined on the cover plate 106 to receive separator 112. The separator receiver 110 may receive one end of the separator 112 to fix the separator 112 perpendicularly to the cover plate 106. In one embodiment, the separator 112 is a baffle to define multi-pass fluid flow circuit 10. Further, the housing 102 includes depletions 202 to receive other side of the separator 112 in the base portion 104.

In this example as shown in FIG. 11, the cover plate 106 has one separator 112, so the base portion 104 is provided with one depletion 202. The depletion 202 provided in the base portion 104 receives one end of the separator 112 and other end of the separator 112 being received in the separator receiver 110 formed in the cover plate 106. Further, the separator 112 is connected between the cover plate 106 and the base portion 104. In such case, the separator 112 may form a baffle that defines two fluid-pass sections. Further, the separator 112 may comprise a recessed section 216 configured on a side of the separator to form fluid communication between the two-section of fluid flow within the housing 102. In other words, the fluid flowing in one section of the housing 102 can be communicated to the other section of the housing 102 through the recessed section 216.

FIG. 11 illustrates an exploded view of the housing 102 showing the cover plate 106 of FIG. 4. The separator 112 of the cover plate 106 may comprise protrusions 212 formed on a side of the separator 112. Further, the protrusions 212 may be adapted to be received in the separator receiver 110 of the cover plate 106. In this embodiment, one end of the separator 112 may be received in the separator receiver 110 and another end of the separator 112 may be received in the depressions 202 formed in the base portion 104 of the housing 102. In other words, the separator 112 may be disposed between the cover plate 106 and the base portion 104 of the housing 102. In another aspect of the invention, the cover plate 106 may comprise more than one separator 112 to define multiple-fluid path in the housing 102. In such case, multiple rows of separator receivers 110 and depressions 202 are formed in the cover plate 106 and the base portion 104 of the housing 102 respectively. As explained above, the housing 102 can be U-shaped housing and the cover plate 106 is connected on the open end of the U-shaped housing to form a closed housing. The cover plate 106 is brazed to the U-shaped housing. To braze the cover plate 106 with the housing 102, the housing 102 along with the cover plate 106 is placed in the brazing machine in such a way that the cover plate 106 facing bottom of the brazing machine. Thereafter, the connection points 302 between the cover plate 106 and the housing 102 is brazed. As the connection points 302 formed on one side of the housing 102, it is possible to positon the connection points 302 of the housing 102 pointing towards bottom of the brazing machine in the brazing holder, thereby eliminating spreading molten brazing material on the core of the heat exchanger 100. As the connecting points 302 have two elements i.e., end of the cover plate 106 and the perpendicular portions 102A-B of the housing 102, brazing between the cover plate 106 and the perpendicular portions 102A-B of the housing 102 can be optimal or fluid tight, thereby eliminating fluid leakage from the connection points 302 of the housing 102. Further, if any gap formed in the connection points 302 due to lack of tolerance of different elements in the heat exchanger 100, the sealing portion 108 can compensate it. The sealing portion 108 is configured to overlap on the gap formed in the connection points 302, thereby eliminating the gap, which is prone for leakage of the fluid. As the number of elements at the connection points 302 are limited, so asynchronous tolerances of the elements can be avoided. Although the features are explained with respect to the chiller, it can be applied any other heat exchanger.

In any case, the invention cannot and should not be limited to the embodiments specifically described in this document, as other embodiments might exist. The invention shall spread to any equivalent means and any technically operating combination of means.

1. A heat exchanger, comprising:
a bundle of elongated tubes comprising open ends for a first fluid;
a pair of manifolds located on both sides of the open ends of the elongated tubes;
a housing configured to form a conduit for a second fluid and at least partially encapsulating the elongated tubes,
wherein the housing comprises an inner surface facing the elongated tubes, and at least one connection point formed by two perpendicular portions of the housing,
wherein one of the perpendicular portions comprises a bent section forming the connection point by parallel arrangement with the other perpendicular portion,
wherein the heat exchanger further comprises at least one sealing portion located at least within the housing, so that the sealing portion overlaps at least portion of the connection point adjacent to at least one manifold.

2. The heat exchanger according to claim 1,
wherein the manifold comprises at least one header comprising open ends to receive the elongated tubes,
wherein the header is encapsulated by the housing.

3. The heat exchanger according to claim 1,
wherein the manifold comprises at least one header comprising an opening to receive the elongated tubes,
wherein the header is located beyond the housing.

4. The heat exchanger according to claim 1,
wherein the housing is formed by at least one plate comprising at least one connection point.

5. The heat exchanger according to claim 1,
wherein the housing is formed by a base portion and a cover plate, wherein the cover plate with base portion forms two connection points.

6. The heat exchanger according to claim 5,
wherein the base portion is essentially U-shaped and the cover plate is essentially flat,
wherein the cover plate comprises bent sections for arranging the connection points at the terminal ends thereof.

7. The heat exchanger according to claim 6,
wherein the cover plate comprises at least one separator configured to form a path for the second fluid within the housing,
wherein the cover plate further comprises a separator receiver configured to fix the separator perpendicularly to the cover plate.

8. The heat exchanger as claimed in claim 7,
wherein the housing comprises a depletion configured to receive the free end of the separator in the base portion.

9. The heat exchanger as claimed in claim 7,
wherein the separator comprises a recessed section configured to form fluid communication between the two-sections of fluid flow within the housing.

10. The heat exchanger as claimed in claim 1, wherein the sealing portion is formed by an elongated L-shaped portion.

11. The heat exchanger according to claim 1,
wherein the sealing portion is formed by an elongated ring portion.

12. The heat exchanger according to claim 11,
wherein the sealing portion further comprises a spacer plate protruding therefrom,
wherein the spacer plate is located in-between the manifold and the housing.
